(19) United States
(12) Patent Application Publication
(10) Pub. No.: US 2010/0227248 A1
(43) Pub. Date: Sep. 9, 2010

(54) Membrane fuel cell with composite electrode plates

(75) Inventors: Chung-jen Tseng, Zhongli City (TW); Bing-Tsang Tsai, Fuxing Shiang (TW); Fong-jhang Chen, Zhongli City (TW)

Correspondence Address: Jackson Intellectual Property Group PLLC, 106 Starvale Lane, Shipman, VA, 22971, US

(73) Assignee: National Central University, Taoyuan (TW)

(21) Appl. No.: 12/081,387

(22) Filed: Apr. 15, 2008

(30) Foreign Application Priority Data
Nov. 8, 2007 (TW) 096142163

(51) Int. Cl. H01M 8/10

(52) U.S. Cl. 429/483

(57) ABSTRACT

A membrane fuel cell includes a membrane electrode assembly sandwiched between two composite electrode plates. The membrane electrode assembly is sandwiched between the composite electrode plates, and includes an anode, a cathode, two catalyst layers sandwiched between the anode and the cathode, and a proton exchange membrane sandwiched between the catalyst layers. Each of the composite electrode plates includes at least one porous layer, at least one conductive layer attached to the porous layer, and at least one partition attached to the conductive layer.

### FIELD OF THE INVENTION

The present invention relates to a membrane fuel cell and, more particularly, to a membrane fuel cell with composite electrode plates.

### DESCRIPTION OF THE RELATED ARTS

Fuel cells are highly efficient and environmentally friendly and can be used in various industries such as the power industry, the transportation industry, the aerospace industry and the munitions industry. Hence, a lot of efforts have been cast on the exploration of this new energy source.

Among the fuel cells, proton exchange membrane fuel cells are the simplest regarding the choice of materials, the control of temperature, security and maintenance. The cost in the system integration is low. The proton exchange membrane fuel cells are therefore the most promising fuel cells. However, there are problems with the proton exchange membrane fuel cells.

Referring to FIG. 5, a conventional proton exchange membrane fuel cell 2 includes a membrane electrode assembly 21 sandwiched between two electrode plates 22. The membrane electrode assembly 21 includes an anode 213, a cathode 214, two catalyst layers 212 sandwiched between the anode 213 and the cathode 214 and a proton exchange membrane 211 sandwiched between the catalyst layers 212. Hydrogen is transmitted in tunnels 221 defined in an internal side of the anode 213. Oxygen is transferred in tunnels 221 defined in an internal side of the cathode 214. The efficiency of the generation of electricity is determined by the efficiency of the chemical reaction between the hydrogen and oxygen at the membrane electrode assembly 21. The efficiency of the chemical reaction between the hydrogen and oxygen at the membrane electrode assembly 21 is determined by the smoothness in the transmission of the hydrogen and oxygen and the evenness in the contact of the hydrogen and oxygen with the membrane electrode assembly 21. To ensure the smoothness in the transmission of the hydrogen and oxygen and the evenness in the contact of the hydrogen and oxygen with the membrane electrode assembly 21, the length and the shape and size of the cross-section of the tunnels 221 are important.

Disclosed in Taiwanese Patent Publication M481937 is a conventional fuel cell with wavy electrode plates. Disclosed in Taiwanese Patent Publication M459418 is a conventional fuel cell with two electrode plates in which tunnels for fuel and tunnels for oxidizer are alternately arranged. The advantages of these conventional fuel cells over the conventional fuel cell shown in FIG. 5 are limited since the fuel and oxidizer are limited in the electrode plates.

Referring to FIG. 6, there is shown another conventional membrane fuel cell 3 as disclosed in Taiwanese Patent Publication M553496. The membrane fuel cell 3 includes a membrane electrode assembly 31 sandwiched between two porous electrode plates 32a and 32b. The membrane electrode assembly 31 includes an anode 313, a cathode 314, two catalyst layers 312a ad 312b sandwiched between the anode 313 and the cathode 314 and a proton exchange membrane 311 sandwiched between the catalyst layers 312a and 312b. The electrode plate 32a includes a non-porous layer 322a sandwiched between two porous layers 321a. The electrode plate 32b includes a non-porous layer 322b sandwiched between two porous layers 321b. However, there are some problems with this conventional membrane fuel cell 3. Firstly, the porous and non-porous layers must be made of metal that is conductive or they could not be used to generate electricity. Secondly, the porous and non-porous layers must be made of a same material or the efficiency of the generation of electricity would be affected. Thirdly, the porous and non-porous layers could easily get excessively hot during the generation of electricity so that the efficiency is affected and that the life of the membrane fuel cell 3 is reduced.

The present invention is therefore intended to obviate or at least alleviate the problems encountered in prior art.

### SUMMARY OF THE INVENTION

It is the primary objective of the present invention to provide a light, small and inexpensive membrane fuel cell.

According to the present invention, a membrane fuel cell includes a membrane electrode assembly sandwiched between two composite electrode plates. The membrane electrode assembly is sandwiched between the composite electrode plates, and includes an anode, a cathode, two catalyst layers sandwiched between the anode and the cathode, and a proton exchange membrane sandwiched between the catalyst layers. Each of the composite electrode plates includes at least one porous layer, at least one conductive layer attached to the porous layer, and at least one partition attached to the conductive layer.

Other objectives, advantages and features of the present invention will become apparent from the following description referring to the attached drawings.

### BRIEF DESCRIPTION OF THE DRAWINGS

The present invention will be described via the detailed illustration of the preferred embodiment referring to the drawings.

FIG. 1 is an exploded view of a membrane fuel cell according to the preferred embodiment of the present invention.

FIG. 2 is a front view of a composite electrode plate used in the membrane fuel cell shown in FIG. 1.

FIG. 3 is a partial and exploded view of the membrane fuel cell shown in FIG. 1.

FIG. 4 is a cross-sectional view of the membrane fuel cell shown in FIG. 1.

FIG. 5 is a cross-sectional view of a conventional membrane fuel cell.

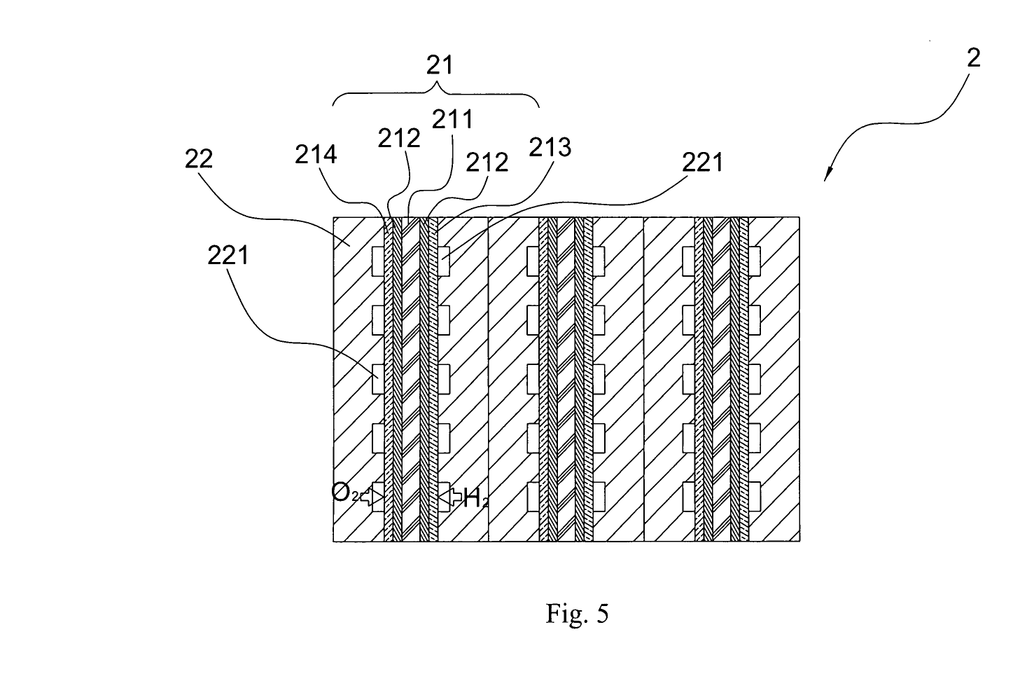

FIG. 6 is a cross-sectional view of another conventional membrane fuel cell.

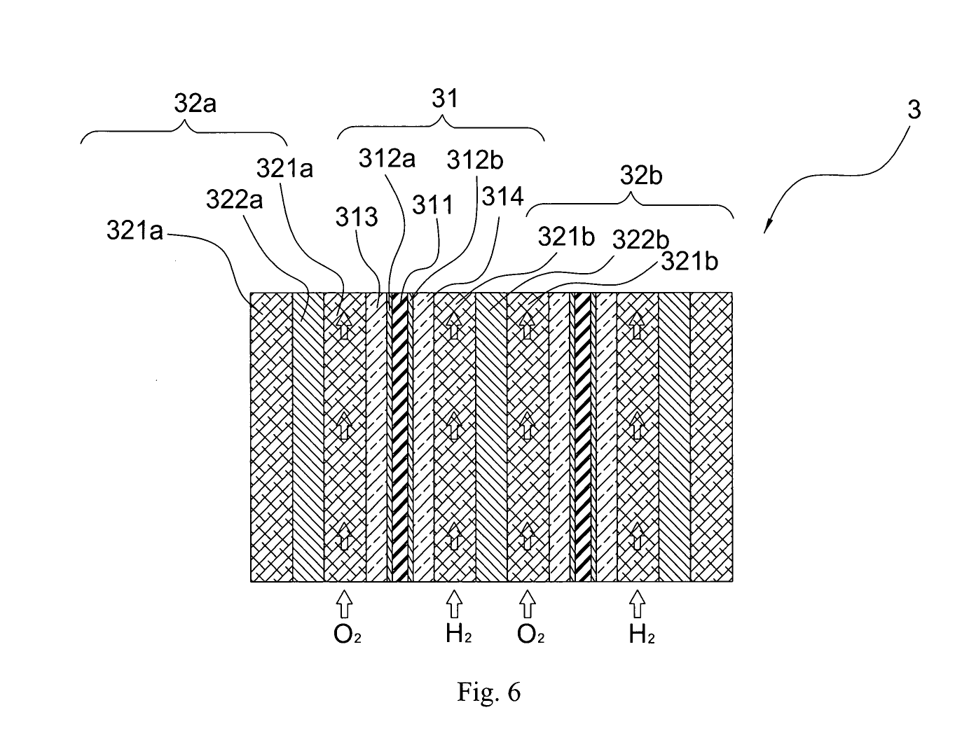

### DETAILED DESCRIPTION OF EMBODIMENT

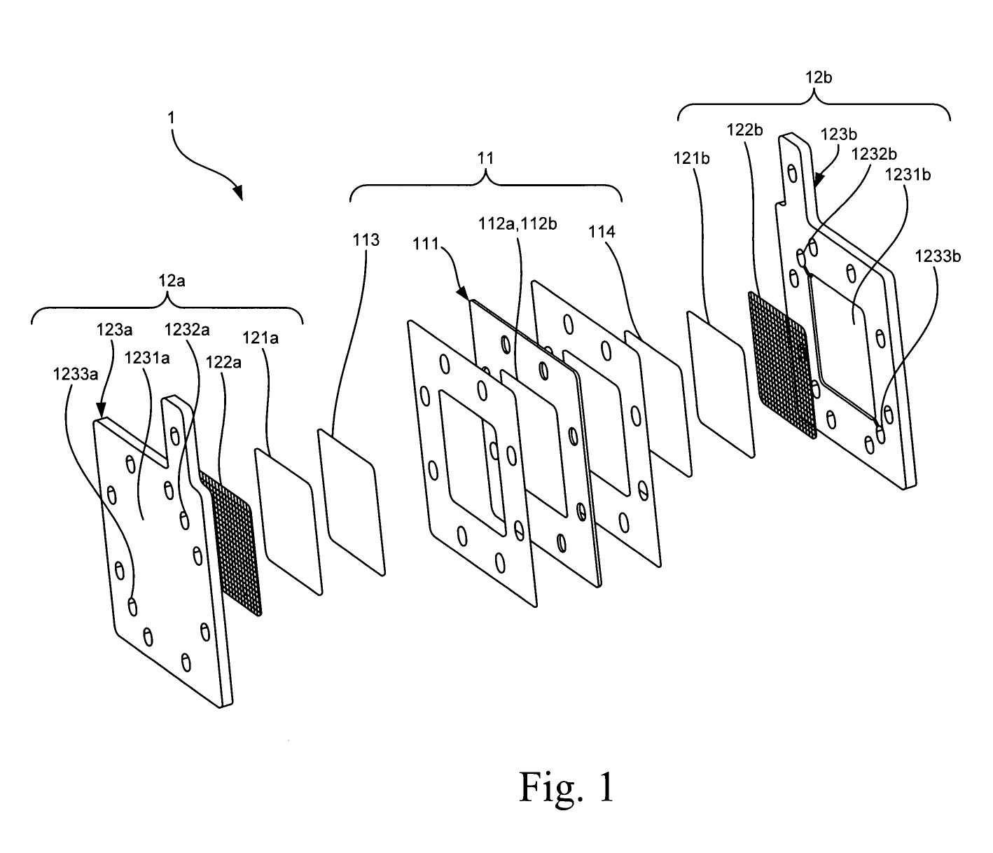

Referring to FIG. 1, a membrane fuel cell 1 includes a membrane electrode assembly 11 sandwiched between two composite electrode plates 12a and 12b according to the preferred embodiment of the present invention. The composite electrode plates 12a and 12b are structurally identical to each other.

The membrane electrode assembly 11 includes a proton exchange membrane 111, a catalyst layer 112a attached to a side of the proton exchange membrane 111, a catalyst layer 112b attached to an opposite side of the proton exchange membrane 111, an anode 113 attached to the catalyst layer 112a and a cathode 114 attached to the catalyst layer 112b.

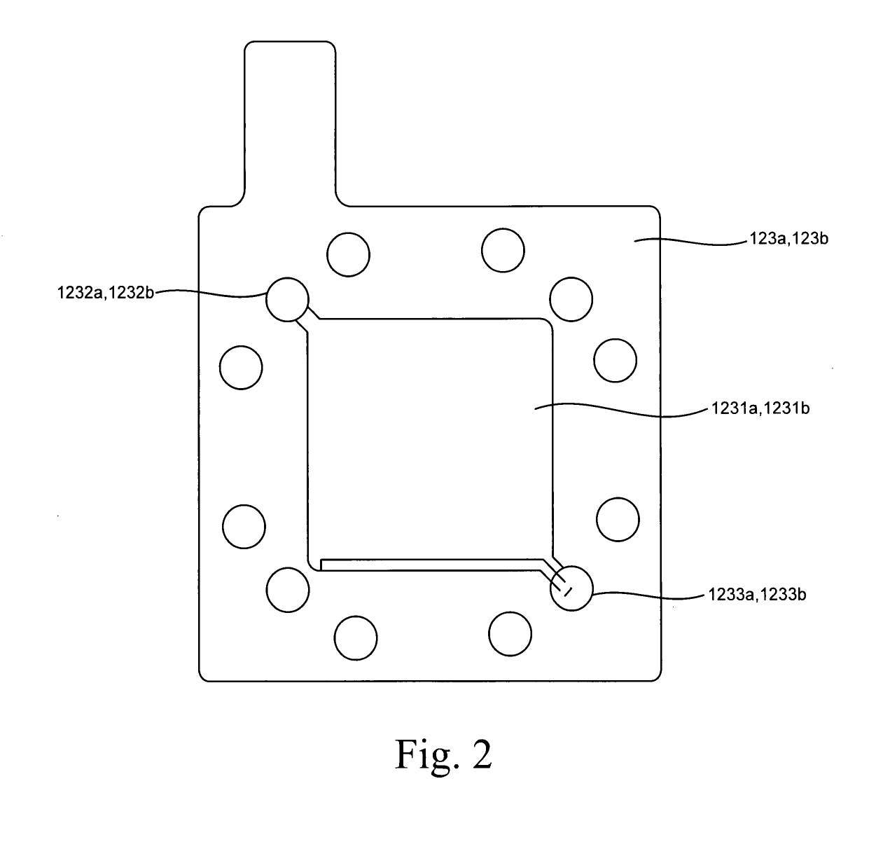

The composite electrode plate 12a includes a porous layer 121a, a conductive layer 122a attached to the porous layer 121a and a partition 123a attached to the conductive layer 122a. Referring to FIG. 2, a cavity 1231a, a fuel entrance 1232a and a fuel exit 1233a are defined in a side of the partition 123a. The fuel entrance 1232a and the fuel exit 1233a are in communication with the cavity 1231a. The partition 123a includes apertures 1234a for the transmission of fuel and oxidizer, the emission of water and the radiation of heat.

Similarly, the composite electrode plate 12b includes a porous layer 121b, a conductive layer 122b and a partition 123b. The partition 123b includes a cavity 1231b, a fuel entrance 1232b, a fuel exit 1233a and apertures 1234b.

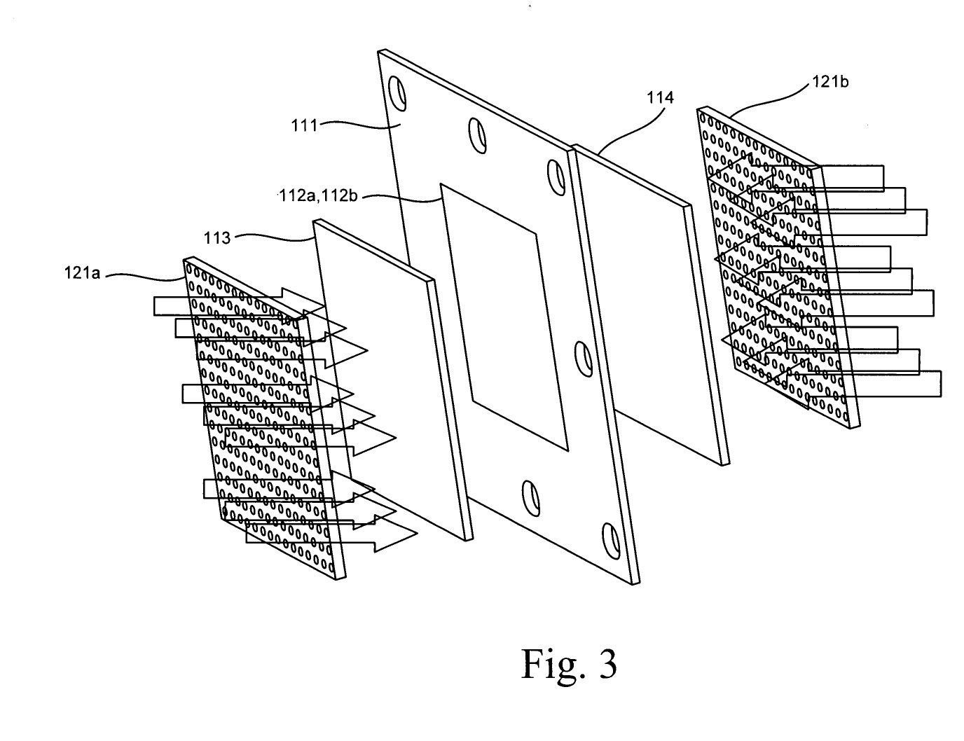

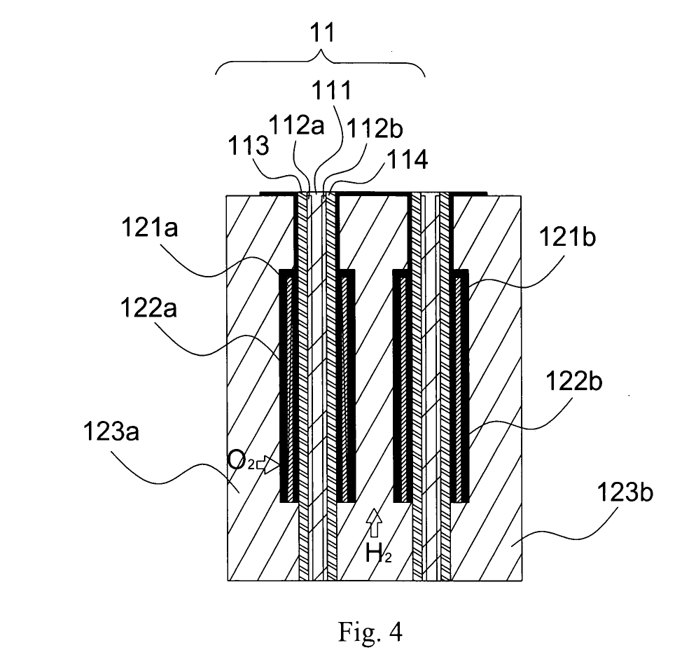

Referring to FIGS. 3 and 4, the porous layer 121a

The composite electrode plates 12a and 12b, the porous layers 121a and 121b and the partitions 123a and 123b may be made of a conductive or isolating material, independent of one another. The size of the proton exchange membrane 111 of the membrane electrode assembly 11 is matched with the size of the cavities 1231a and 1231b of the partitions 123a and 123b, respectively. The porous layer 121a is disposed within the cavity 1231a of the partition 123a. The porous layer 121b is disposed within the cavity 1231b of the partition 123b. The excellent conductivity of the conductive layers 122a and 122b deliver electrons to the cathode 114 from the anode 113. Therefore, during the operation of the membrane fuel cell 1, a current does not have to go through the partitions 123a and 123b.

The composite electrode plates 12a and 12b are used in the membrane fuel cell 1 instead of bulky and heavy graphite electrode plates used in a conventional membrane fuel cell. The functions of the graphite electrode plates are shared by the components of the composite electrode plates 12a and 12b. The porous layers 121a and 121b are used for the inlet of the fuel and oxidizer and the emission of the water. The conductive layers 122a and 122b are used to accumulate the electricity. The partitions 123a and 123b are used for the mechanical support of the membrane fuel cell 1. Therefore, the membrane fuel cell 1 is small and light. The materials used in the membrane fuel cell 1 are few, the production is fast, and the cost is low. Furthermore, the membrane fuel cell 1 can be used in a power plant or a portable electronic device.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A membrane fuel cell comprising:
two composite electrode plates each comprising at least one porous layer, at least one conductive layer attached to the porous layer, and at least one partition attached to the conductive layer; and
a membrane electrode assembly sandwiched between the composite electrode plates and comprised of an anode, a cathode, two catalyst layers sandwiched between the anode and the cathode, and a proton exchange membrane sandwiched between the catalyst layers.

2. The membrane fuel cell according to claim 1, wherein the porous layer is made of a material selected from a group consisting of conductive materials and isolating materials.

3. The membrane fuel cell according to claim 1, wherein the partition is made of a material selected from a group consisting of conductive materials and isolating materials.

4. The membrane fuel cell according to claim 1, wherein the partition comprises apertures defined therein for the transmission of fuel and oxidizer, the emission of water and the radiation of heat.

5. The membrane fuel cell according to claim 1, wherein the partition comprises a cavity defined in a side for receiving the porous layer.

6. The membrane fuel cell according to claim 5, wherein the partition comprises a fuel entrance in communication with the cavity and a fuel exit in communication with the cavity.
